(19) United States
(12) Patent Application Publication
(10) Pub. No.: US 2025/0118000 A1
(43) Pub. Date: Apr. 10, 2025

(54) METHOD, APPARATUS, ELECTRONIC DEVICE, AND STORAGE MEDIUM FOR IMAGE PROCESSING

(71) Applicant: Beijing Zitiao Network Technology Co., Ltd., Beijing (CN)

(72) Inventor: Meng Yan, Beijing (CN)

(21) Appl. No.: 18/912,065

(22) Filed: Oct. 10, 2024

(30) Foreign Application Priority Data
Oct. 10, 2023 (CN) 202311309632.1

(51) Int. Cl. G06T 11/60; G06T 3/40; G06T 7/12; G06T 7/13; G06T 19/20; G06V 10/46

(52) U.S. Cl. CPC G06T 11/60; G06T 3/40; G06T 7/12; G06T 7/13; G06T 19/20; G06V 10/46; G06T 2219/2016

(57) ABSTRACT

Embodiments of the disclosure provide a method, an apparatus, an electronic device, and a storage medium for image processing. The method includes: obtaining a target image to be processed in response to a first trigger operation, generating and displaying an effect image corresponding to the target image, the effect image including an effect contour line corresponding to a target object in the target image, the effect contour line being associated with an outer contour line of the target object, and a relative distance between the effect contour line and the outer contour line being a first distance; and in response to a second trigger operation input for the effect contour line, adjusting the relative distance between the effect contour line in the effect image and the outer contour line of the target object from the first distance to a second distance for display.

### CROSS REFERENCE

The present application claims priority to Chinese Patent Application No. 202311309632.1, filed on Oct. 10, 2023 and entitled “METHOD, APPARATUS, ELECTRONIC DEVICE, AND STORAGE MEDIUM FOR IMAGE PROCESSING”, the entirety of which is incorporated herein by reference.

### FIELD

Embodiments of the present disclosure relate to computer application technologies, particularly a method, an apparatus, an electronic device, and a storage medium for image processing.

### BACKGROUND

In a scene of image processing or video production, the application of effect props is favored by users. Users may process images or videos by using a selected effect prop, so that an obtained effect image presents an effect corresponding to the effect prop.

In the related art, when effect processing is performed, an effect image or an effect video obtained based on any triggered effect prop may be displayed after the effect prop is triggered. However, the effect image or the effect video currently displayed has a fixed effect corresponding to the triggered effect prop, and users cannot adjust the effect in the effect image or the effect video. Therefore, the display effect of the effect image or the effect video based on the effect prop is relatively monotonous, unable to meet the diverse editing needs of users for effects of the effect prop. This imposes certain limitations and affects the use experience with effect props.

### SUMMARY

The present disclosure provides a method, an apparatus, an electronic device, and a storage medium for image processing, so that users can customize a relative distance between an effect contour line and a target object in an effect image, thereby enhancing the richness and interest of the effect image content.

In a first aspect, embodiments of the present disclosure provide a method of image processing, comprising:
obtaining a target image to be processed in response to a first trigger operation, generating and displaying an effect image corresponding to the target image, the effect image comprising an effect contour line corresponding to a target object in the target image, the effect contour line being associated with an outer contour line of the target object, and a relative distance between the effect contour line and the outer contour line being a first distance; and
in response to a second trigger operation input for the effect contour line, adjusting the relative distance between the effect contour line in the effect image and the outer contour line of the target object from the first distance to a second distance for display.

In a second aspect, the embodiments of the present disclosure further provide an apparatus for image processing, comprising:
an effect triggering module, configured to obtain a target image to be processed in response to a first trigger operation, generate an effect image corresponding to the target image, and display the effect image, the effect image comprising an effect contour line corresponding to a target object in the target image, the effect contour line is associated with an outer contour line of the target object, and a relative distance between the effect contour line and the outer contour line being a first distance; and
a distance adjusting module, configured to, in response to a second trigger operation input for the effect contour line, adjust the relative distance between the effect contour line in the effect image and the outer contour line of the target object from the first distance to a second distance for display.

In a third aspect, the embodiments of the present disclosure further provide an electronic device, comprising:
one or more processors;
a storage device storing one or more programs which, when executed by the one or more processors, cause the one or more processors to implement any method of image processing according to the embodiments of the present disclosure.

In a fourth aspect, the embodiments of the present disclosure further provide a storage medium comprising computer-executable instructions, where the computer-executable instructions, when executed by a computer processor, implement any method of image processing according to the embodiments of the present disclosure.

### BRIEF DESCRIPTION OF DRAWINGS

The above and other features, advantages, and aspects of various embodiments of the present disclosure will become more apparent from the following detailed description taken in combination with the drawings. Throughout the drawings, the same or similar reference numbers refer to the same or similar elements. It should be understood that the drawings are schematic, and elements are not necessarily drawn to scale.

FIG. 1 is a schematic flowchart of a method of image processing according to the embodiments of the present disclosure;

FIG. 2 is a schematic diagram of a display effect of an outer contour line and an effect contour line according to the embodiments of the present disclosure;

FIG. 3 is a schematic flowchart of a further method of image processing according to the embodiments of the present disclosure;

FIGS. 4a and 4b are schematic diagrams of a display effect of an object mask image and a mask expanded image according to the embodiments of the present disclosure;

FIG. 5 is a schematic diagram of a display effect of an expanded image according to the embodiments of the present disclosure;

FIG. 6 is a schematic diagram of a display effect of target texture information according to the embodiments of the present disclosure;

FIGS. 7a and 7b are schematic diagrams of a display effect of an effect contour line filled with target texture information and an effect contour line unfilled with target texture information according to the embodiments of the present disclosure;

FIG. 8 is a schematic flowchart of a further method of image processing according to the embodiments of the present disclosure;

FIG. 9 is a schematic structural diagram of an apparatus for image processing according to the embodiments of the present disclosure; and

FIG. 10 is a schematic structural diagram of an electronic device according to the embodiments of the present disclosure.

### DETAILED DESCRIPTION

Embodiments of the present disclosure will be described in more detail below with reference to the drawings. While certain embodiments of the present disclosure are shown in the drawings, it is to be understood that the present disclosure may be implemented in various forms, and should not be construed as limited to the embodiments set forth herein, and vice versa. It should be understood that the drawings and embodiments of the present disclosure are for exemplary purposes only and are not intended to limit the scope of the present disclosure.

It should be understood that the steps recited in the method embodiments of the present disclosure may be performed in different orders, and/or in parallel. Further, the method embodiments may include additional steps and/or omit to perform the illustrated steps. The scope of the present disclosure is not limited in this respect.

As used herein, the term “comprising” and deformation thereof are open-ended, i.e., “comprising but not limited to”. The term “based on” is “based at least in part on”. The term “one embodiment” means “at least one embodiment”; the term “a further embodiment” means “at least a further embodiment”; the term “some embodiments” means “at least some embodiments”. The relevant definition of other terms will be given below.

It should be noted that concept concepts such as “first” and “second” mentioned in this disclosure are merely used to distinguish different apparatuses, modules, or units, and are not intended to limit the order of functions performed by the apparatuses, modules, or units or the mutual dependency relationship.

It should be noted that the modification of “a” and “a plurality” mentioned in this disclosure is illustrative and not limiting, and those skilled in the art should understand that “one or more” should be understood unless the context clearly indicates otherwise.

The names of messages or information interaction between multiple devices in the embodiments of the present disclosure are for illustrative purposes only and are not intended to limit the scope of such messages or information.

It can be understood that, before the technical solutions disclosed in the embodiments of the present disclosure are used, the types of personal information related to the present disclosure, the usage scope, the usage scenario, and the like should be notified to the user in an appropriate manner according to the relevant laws and regulations and obtain the authorization of the user.

For example, in response to receiving an active request from a user, prompt information is sent to the user to explicitly prompt the user that the requested operation will need to obtain and use the personal information of the user. Therefore, the user can autonomously select whether to provide personal information to software or hardware executing the operation of the technical solution of the present disclosure according to the prompt information.

As an optional but non-limiting implementation, in response to receiving the active request of the user, the manner of sending the prompt information to the user may be, for example, a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process is merely illustrative and does not constitute a limitation on implementations of the present disclosure, and other manners of meeting related laws and regulations may also be applied to implementations of the present disclosure.

It may be understood that the data involved in the technical solution (including but not limited to the data itself, the acquisition or use of the data) should follow the requirements of the corresponding laws and regulations and related regulations.

Before the technical solution is introduced, the application scenario may be described first. The technical solution can be applied to a scenario where the effect of the effect image is adjusted under the condition that the effect image is determined. For example, it is assumed that the effect is to generate an effect contour line corresponding to a target object in a target image. After the target image is obtained, effect processing may be performed on the target image to obtain an effect image corresponding to the target image, where the effect image comprises an effect contour line corresponding to the target object in the target image. In the existing method of image processing, after the effect image is obtained, the effect image is used as the final effect output image, and the effect in the effect image cannot be adjusted; alternatively, after the effect image is obtained, only an effect element in the effect image can be adjusted again, and the overall effect of the effect image cannot be adjusted again, resulting in a relatively monotonous display effect of the effect image or the effect video produced based on an effect prop, which cannot meet diverse editing needs of users for effects of the effect prop, and has certain limitations. In this case, based on the technical solution of the embodiments of the present disclosure, after the effect image corresponding to the target image is determined, a trigger operation for adjusting distance may be input for the effect contour line in the effect image. Then the trigger operation may be responded to adjust the relative distance between the effect contour line in the effect image and the outer contour line of the target object, and the effect image is updated based on the adjusted relative distance. Therefore, the effect allowing users to customize and adjust the effect in the effect image is achieved, which enhances the flexibility of editing the effect and improves the user experience in using effect props.

Before the technical solution is described, it should be noted that the apparatus for performing the method of image processing provided in the embodiments of the present disclosure may be integrated into application software that supports image processing functions, and the software may be installed in an electronic device, and alternatively, the electronic device may be a mobile terminal or a PC terminal. The application software may be a type of software for image/video processing, and the specific application software thereof is not described in detail here, as long as it can achieve image/video processing. The application may also be a specifically developed application and integrated into the software for image processing, or integrated into a corresponding page, allowing users to process images through the integrated page in the PC terminal.

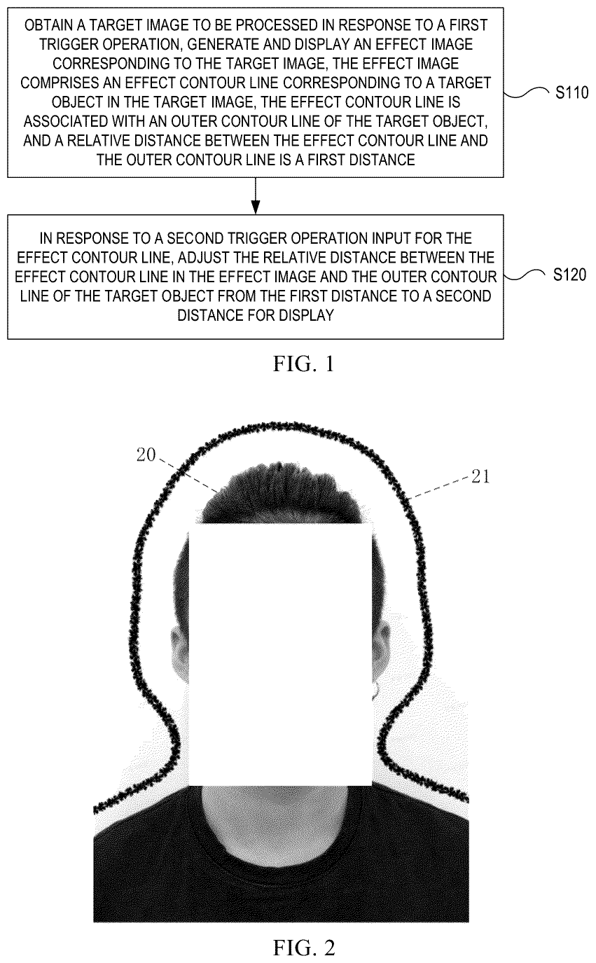

FIG. 1 is a schematic flowchart of a method of image processing according to the embodiments of the present disclosure. The embodiments of the present disclosure are applicable to a scenario of adjusting an effect contour in an effect image that has been generated. This method may be executed by an apparatus for image processing, which may be implemented in the form of software and/or hardware. Alternatively, it can be implemented through an electronic device, such as a mobile terminal, a PC terminal, a server, and so on.

As shown in FIG. 1, the method in the embodiments of the present disclosure may specifically comprise the following.

S110: a target image to be processed is obtained in response to a first trigger operation. An effect image corresponding to the target image is generated and displayed. The effect image comprises an effect contour line corresponding to a target object in the target image. The effect contour line is associated with an outer contour line of the target object, and a relative distance between the effect contour line and the outer contour line is a first distance.

The first trigger operation may be understood as an effect-triggering operation, that is, an operation for generating and displaying the effect image after triggering. In the embodiments of the present disclosure, a control for triggering the effect may be preset in software or application that supports the processing of effect videos, and in response to a detection that the control is triggered by a user, the first trigger operation may be responded to. Therefore, the target image to be processed is obtained.

The target image may be an image that needs effect processing. It should be noted that the target image may be an unprocessed original image, or may be an image obtained after the original image is processed in a predetermined processing manner, which is not specifically limited in the embodiments of the present disclosure. The predetermined processing manner may include multiple image processing manners, alternatively, it may include cropping processing, grayscale processing, stylization processing, and filter processing.

Alternatively, if the target image is an unprocessed original image, the target image may be an image collected based on the terminal device, or may be an image pre-stored in the application software from the storage space. The terminal device may refer to an electronic product with an image-shooting function such as a camera, a smartphone, and a tablet computer. In practical applications, if it is detected that a user triggers an effect operation, the terminal device may capture an image of an object to which an effect will be applied, and the obtained image is determined as the target image; or if it is detected that a user triggers the effect operation, a plurality of images associated with the effect are determined in a database. Further, one or more images may be determined as the target image based on a predetermined screening rule.

It should be noted that the technical solution of the embodiments of the present disclosure may be performed in a process in which a user shoots a video, that is, an effect video is generated in real time based on an effect prop selected by the user and a recorded video, or a video uploaded by the user may be used as original data, and then an effect video is generated based on the technical solution of the embodiments of the present disclosure.

In practical applications, the target image may be obtained only when certain effect operations are triggered. Alternatively, the first trigger operation may include at least one of the following triggering manners: triggering an effect prop; triggering an effect wakeup word by audio information; and a current body action being consistent with a predetermined body action.

In this embodiment, a control for triggering the effect prop may be predetermined. When a user triggers the control, a display interface of effect props may pop up in a display interface, where multiple effect props may be displayed in the display interface. The user may trigger a corresponding effect prop, and when it is detected that the user triggers the effect prop corresponding to obtaining the target image, it may be indicated that the first trigger operation is triggered. In another implementation, audio information of a user may be collected in advance, and the collected audio information may be analyzed and processed. Further, a text corresponding to the audio information may be recognized. If the recognized text includes a predetermined wakeup word (for example, the wakeup word may be a phrase such as “take a photo”, “open XX effect”, or the like), it indicates that the target image in the display interface may be obtained. In another implementation, some body actions may be predetermined as effect triggering actions in advance. If it is detected that the body action currently performed by an object to which an effect will be applied within the field of view of the terminal device is consistent with the predetermined body action, it may be determined that the effect operation is triggered. Alternatively, the predetermined body action may be raising hands, opening mouth, or turning head.

In the embodiments of the present disclosure, after the target image is obtained, the effect image corresponding to the target image may be generated. The effect image may be understood as an image with an effect contour line added to the target image, and the effect contour line may correspond to a target object in the target image. The effect contour line may be an effect line representing an external contour of the target object in the target image, and displaying an effect. The target object may be an object that needs effect processing in the target image. It should be noted that the target image may include one or more objects, after responding to the first trigger operation and obtaining the target image, the object in the target image may be detected, and the detected object is determined as the target object. Alternatively, after the target image is obtained, an object that needs effect processing may be determined based on the user selection, and the object may be determined as the target object. Further, the effect line added to the target object may be the effect contour line. The target object may be any object. Alternatively, the target object may be one or more of a person, an animal, or a building. The number of the target objects may be one or multiple, and regardless of whether there is one or more of them, they may be all processed by using the technical solutions provided in the embodiments of the present disclosure.

According to the technical solution provided by the embodiments of the present disclosure, a target image to be processed is obtained in response to a first trigger operation, and an effect image corresponding to the target image is generated and displayed. The effect image comprises an effect contour line corresponding to a target object in the target image, the effect contour line is associated with an outer contour line of the target object, and a relative distance between the effect contour line and the outer contour line is a first distance. Therefore, an effect associated with the outer contour line of the target object is provided. Further, in response to a second trigger operation input for the effect contour line, the relative distance between the effect contour line in the effect image and the outer contour line of the target object is adjusted from the first distance to a second distance for display. In this way, an interaction entrance for adjusting the effect is provided for users, and the problem in the related art is solved, which is that the effect in the effect image or the effect video cannot be adjusted, resulting in a relatively monotonous visual effect of the effect image or the effect video created based on the effect prop, and the inability to meet the diverse editing needs of users for the effects of the effect prop. It realizes the effect of allowing users to customize the relative distance between the effect contour line and the target object in the effect image, enhancing the richness and interest of the effect image content, while also strengthening the interactive effect with users and improving their user experience with the effect prop.

Specifically, the effect contour line is associated with the outer contour line of the target object. The effect contour line may be obtained by scaling up or scaling down the outer contour line of the target object; and/or the effect contour line may change as the outer contour line of the target object changes. In an example, as shown in FIG. 2, a schematic diagram of a display effect of an outer contour line and an effect contour line. It can be seen from FIG. 2 that an effect contour line 21 is obtained by scaling up an outer contour line 20.

In the embodiments of the present disclosure, the outer contour line may be understood as a line representing an edge contour located at the outermost side of the target object. As described above, the effect contour line may be obtained by scaling up or scaling down the outer contour line of the target object. In an alternative processing manner of scaling up or scaling down, after the target object in the target image is determined, edge contour detection may be performed on the target object to determine the outer contour line of the target object. Further, the outer contour line may be scaled up or scaled down, and the effect contour line may be generated based on the outer contour line obtained after scaling up or scaling down. In a further implementation, after the target object is scaled up or scaled down, edge contour detection is performed on the target object after scaling up or scaling down to determine the outer contour line of the target object after scaling up or scaling down, and then the effect contour line is generated based on the detected outer contour line. Alternatively, the outer contour line may be an outline obtained by outlining the target object based on an outlining algorithm.

Alternatively, generating the effect contour line based on the outer contour line obtained after the process of scaling up or scaling down comprises: determining the outer contour line obtained after the process of scaling up or scaling down as the effect contour line; or performing a smoothing process on the outer contour line obtained after the process of scaling up or scaling down, to obtain the effect contour line. Similarly, generating the effect contour line based on the detected outer contour line comprises: determining the detected outer contour line as an effect contour line; or performing a smoothing process on the detected outer contour line to obtain the effect contour line.

In the embodiments of the present disclosure, an image area corresponding to the target object may be expanded or eroded, to scale up or scale down the outer contour line of the target object. At this point, the relative distance between the new contour line and the outer contour line of the target object may be associated with an expansion parameter or an erosion parameter.

In the embodiments of the present disclosure, scaling up or scaling down the outer contour line may be scaling up or scaling down the outer contour line with a same center point, so that the finally obtained effect contour line is a contour line having the same as the center point as the outer contour line and having a different relative distance from the center point. The center point may be understood as a center point corresponding to the target object. The relative distance between the center points may be understood as the distance between any point on the outer contour line or the effect contour line and the center point. In practical applications, the distance between any point on the effect contour line and the center point is determined, and the distance between a corresponding point on the outer contour line and the center point is determined. Further, the difference between the two distances may be determined, and the difference may be determined as the relative distance between the effect contour line and the outer contour line.

It should be noted that the first distance may be a default distance predetermined by a system, or may be a distance displayed on a display interface before the target user exits the effect prop last time, which is not specifically limited in the embodiments of the present disclosure.

In practical applications, in response to the first trigger operation, the target image to be processed is obtained. Further, the target object in the target image may be determined, and the edge contour detection is performed on the target object to determine the outer contour line of the target object. Then, the outer contour line may be scaled up to obtain the effect contour line corresponding to the target object, and the effect image including the effect contour line corresponding to the target image may be obtained. Further, the effect image may be displayed in the display interface of the corresponding terminal device.

S120, in response to a second trigger operation input for the effect contour line, the relative distance between the effect contour line in the effect image and the outer contour line of the target object is adjusted from the first distance to a second distance for display.

The second trigger operation may be understood as a trigger operation for adjusting distance, which is an operation of adjusting the relative distance between the effect contour line and the outer contour line after triggering. In the embodiments of the present disclosure, a distance adjustment control may be preset on the display interface of the effect image, such that users may adjust the distance between the effect contour line and the outer contour line by triggering the control. The distance adjustment control may be in any form, alternatively, it may be a slider, edit box or other forms of control. The second distance may be understood as a distance corresponding to the second trigger operation.

It should be noted that the second distance may be a distance less than the first distance, or may be a distance equal to the first distance, or may be a distance greater than the first distance.

In practical applications, after the effect image is determined, and the effect image is displayed in the display interface, a preset distance adjustment control may further be displayed in the display interface. Upon detecting the trigger operation on the distance adjustment control, it may be determined that the second trigger operation input for the effect contour line is detected. Further, the trigger operation may be responded to, and the relative distance between the effect contour line and the outer contour line of the target object may be adjusted based on the trigger operation. Further, the distance corresponding to the second trigger operation may be determined as the second distance, and the relative distance between the effect contour line and the outer contour line may be adjusted from the first distance to the second distance and displayed. Therefore, in the adjusted effect image that is displayed, the relative distance between the effect contour line and the outer contour line is the second distance.

According to the technical solution provided by the embodiments of the present disclosure, a target image to be processed is obtained in response to a first trigger operation, and an effect image corresponding to the target image is generated and displayed. The effect image comprises an effect contour line corresponding to a target object in the target image, the effect contour line is associated with an outer contour line of the target object, and a relative distance between the effect contour line and the outer contour line is a first distance. Therefore, an effect associated with the outer contour line of the target object is provided. Further, in response to a second trigger operation input for the effect contour line, the relative distance between the effect contour line in the effect image and the outer contour line of the target object is adjusted from the first distance to a second distance for display. In this way, an interaction entrance for adjusting the effect is provided for users, and the problem in the related art is solved, which is that the effect in the effect image or the effect video cannot be adjusted, resulting in a relatively monotonous visual effect of the effect image or the effect video created based on the effect prop, and the inability to meet the diverse editing needs of users for the effects of the effect prop. It realizes the effect of allowing users to customize the relative distance between the effect contour line and the target object in the effect image, enhancing the richness and interest of the effect image content, while also strengthening the interactive effect with users and improving their user experience with the effect prop.

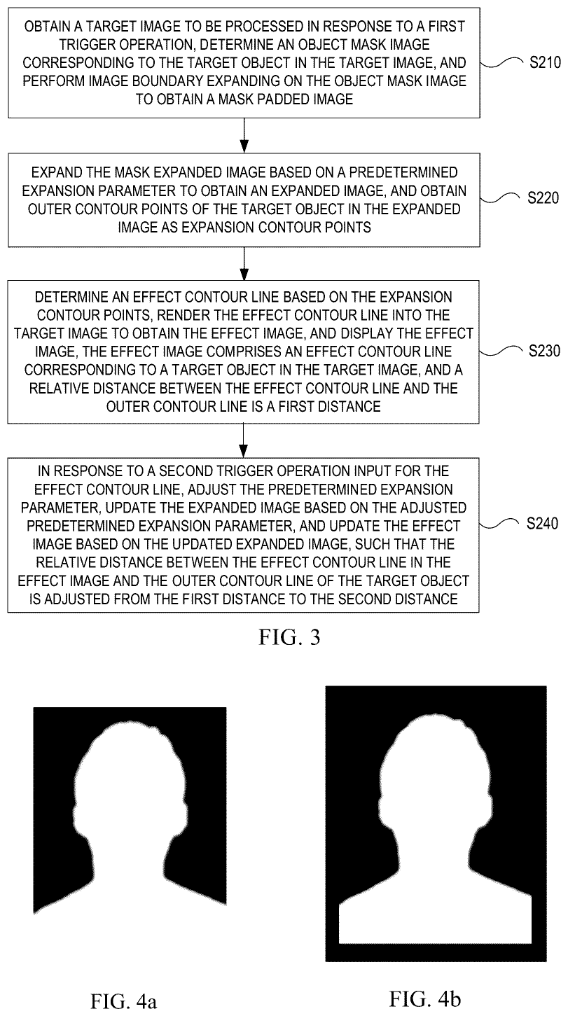

FIG. 3 is a schematic flowchart of a further method of image processing according to the embodiments of the present disclosure. Based on the above embodiments, an object mask image corresponding to the target image is determined, and image boundary expanding is performed on the object mask image to obtain a mask expanded image. Then, the mask expanded image is expanded to obtain an expanded image, and the effect image is generated based on the expanded image and displayed. Therefore, the effect contour line in the displayed effect image may be processed to adjust the relative distance between the effect contour line and the outer contour line of the target object. For a specific implementation, reference may be made to the description of the embodiments of the present disclosure. Technical features that are the same as or similar to the foregoing embodiments are not described here again.

As shown in FIG. 3, the method in the embodiments of the present disclosure may specifically comprises the following.

S210: a target image to be processed is obtained in response to a first trigger operation. An object mask image corresponding to the target object in the target image is determined. Image boundary expanding is performed on the object mask image to obtain a mask expanded image.

The object mask image may be understood as an image representing an outer edge contour of the target object in the target image, or may be understood as a binary image generated by using the display area of the target object in the target image as a region of interest. It may be understood by those skilled in the art that the mask image is a binary image composed of two pixel values. In the field of image processing, the mask image may be used to extract the region of interest. The mask image split from the region of interest in an image may be obtained through adjusting the pixel value in the region of interest to a first pixel value, and adjusting the pixel value of the image outside the region of interest to a second pixel value, where the second pixel value and the first pixel value are two different pixel values. In practical applications, in case that the target object in the target image is determined, the pixel value in the target image corresponding to the target object may be adjusted to a first predetermined pixel value, and the pixel value of pixels other than the target object in the target image may be adjusted to a second predetermined pixel value, to obtain the object mask image corresponding to the target object in the target image. The first predetermined pixel value may be any pixel value, and alternatively, may be 1. The second predetermined pixel value may be any pixel value, and alternatively, may be 0. It should be noted that the first predetermined pixel value and the second predetermined pixel value are two different pixel values, so that the target object in the target image can be distinguished for display.

In the embodiments of the present disclosure, after the object mask image is obtained, image boundary expanding may be performed on the object mask image to obtain the mask expanded image. The image boundary expanding may be understood as expanding a predetermined number of pixels on at least one boundary of the object mask image without changing the image size of the object mask image. The mask expanded image may be understood as an image obtained after expanding the predetermined number of pixels on the at least one boundary of the object mask image. It should be noted that, when the image boundary expanding is performed, image boundary expanding may be performed on at least one image boundary of the object mask image. The at least one image boundary may be an image boundary or may be each of the image boundaries, and the number of the image boundaries on which the image boundary expanding is performed in the embodiments of the present disclosure is not specifically limited. For example, FIG. 4a is an object mask image, and FIG. 4b is a mask expanded image. It can be seen that after the image boundary expanding is performed on each image boundary in the object mask image shown in FIG. 4a, the mask expanded image shown in FIG. 4b can be obtained. As can be seen from FIG. 4b, in the mask expanded image, the display size of the target object in the object mask image does not change, and only a boundary region of a predetermined size is newly added outside each image boundary in the object mask image.

In practical applications, after the target object in the target image is determined, the target image may be masked. Further, the object mask image corresponding to the target object in the target image may be obtained. Further, image boundary expanding may be performed on the object mask image to expand a predetermined number of pixels outside at least one image boundary of the object mask image. Therefore, the expanded image may be determined as a mask expanded image. For example, it is assumed that the width value of the object mask image shown in FIG. 4a is W, and the height value is H. If K pixels are expanded outside each image boundary of the object mask image shown in FIG. 4a to obtain the mask expanded image shown in FIG. 4b, the obtained mask expanded image has a width value of W+2K, and a height value of H+2K.

S220: the mask expanded image is expanded based on a predetermined expansion parameter to obtain an expanded image, and outer contour points of the target object in the expanded image is obtained as expansion contour points.

It should be noted that expanding an image is to expand a highlighted region in the image, so that the highlighted region in the finally obtained expanded image is larger than the highlighted region of the original image, that is, the pixels corresponding to the highlighted region are expanded outwards. If the image boundary expanding is not performed on an image before the image is expanded, the pixels in the highlighted region in the image may not be expanded out of the image due to the limitation of the size of the image during the process of outward expanding, resulting in edge information of the highlighted region being confined within the target image and unable to expand outside of the target image. Therefore, the technical solutions provided in the embodiments of the present disclosure may be used to perform image boundary expanding on the object mask image to obtain the mask expanded image. Further, the mask expanded image is expanded to expand the mask area in the mask expanded image outwards. Thereby, an expanded image can be obtained. The advantage of this arrangement is that in the case that at least part of outer contour lines of the target object in the target image is at the image boundary, the finally generated effect contour line displays an effect of expanding outside of the image, thereby enhancing the effect display of the effect contour line.

Before the image is expanded, the image boundary expanding may be performed on the image first, and then the expanded image may be expanded to obtain the expanded image.

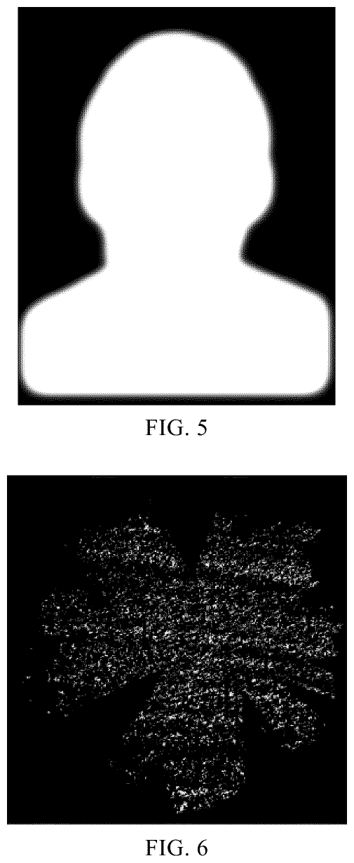

The predetermined expansion parameter may be understood as a predetermined parameter for image expansion. In the embodiments of the present disclosure, the predetermined expansion parameter may match the relative distance between the effect contour line and the outer contour line of the target object. Specifically, in case that the effect image corresponding to the target image is generated in response to the first trigger operation, the first distance between the finally generated effect contour line and the outer contour line of the target object may be determined first. Further, the predetermined expansion parameter may be determined based on the first distance. Further, in response to the second trigger operation input for the effect contour line being detected, the trigger operation may be responded to, and the second distance between the effect contour line corresponding to the trigger operation and the outer contour line of the target object may be determined. Further, the predetermined expansion parameter may be determined based on the second distance. Those skilled in the art may understand that expanding the image may be expanding the highlighted region or the white part in the image, so that the highlighted region or the white part in the finally obtained expanded image is larger than the highlighted region or the white part in the original image. Generally, expanding the image may be expanding the pixels with a higher pixel value in the image. For the embodiments of the present disclosure, the expanding the mask expanded image may be expanding the pixels corresponding to the target object in the mask expanded image, such that a display size of the target object in the finally obtained expanded image is greater than a display size of the target object in the mask expanded image. In an example, as shown in FIG. 4b and FIG. 5, FIG. 5 is an expanded image obtained after the mask expanded image shown in FIG. 4b is expanded. As can be seen from FIG. 5 and FIG. 4b, the display size of the target object in the expanded image is greater than the display size of the target object in the mask expanded image.

In the embodiments of the present disclosure, after the expanded image is obtained, outer contour points of the target object in the expanded image may be obtained as expansion contour points.

The outer contour points may be understood as pixels representing an outer edge contour of the target object in the expanded image.

In practical applications, after the expanded image is obtained, contour line information may be extracted from the target object in the expanded image. Further, outer contour points of the target object in the expanded image may be obtained, and the obtained outer contour points are determined as expansion contour points. It should be noted that the expanded image may be processed based on a predetermined contour extraction algorithm to extract contour line information of the target object in the expanded image. The predetermined contour extraction algorithm may be any contour extraction algorithm, and alternatively, may be a Find Contours algorithm.

S230: an effect contour line is determined based on the expansion contour points, the effect contour line is rendered into the target image to obtain the effect image, and the effect image is displayed. The effect image comprises an effect contour line corresponding to a target object in the target image, and a relative distance between the effect contour line and the outer contour line is a first distance.

In the embodiments of the present disclosure, after the expansion contour points are obtained, the effect contour line may be determined based on the expansion contour point. It should be noted that the expansion contour points are pixels extracted from the expanded image, and the effect contour line needs to be rendered into the target image; the expanded image is obtained by performing image boundary expanding and expansion on the object mask image. The coordinate system corresponding to the expanded image is different from the coordinate system corresponding to the object mask image, and the coordinate system corresponding to the target image is the same as the coordinate system corresponding to the object mask image. Therefore, the coordinate system corresponding to the expanded image is different from that of the target image. In order to determine the effect contour line based on the expanded contour points, coordinate conversion may be performed on the expanded contour points to obtain locations of the expanded contour points in the object mask image. Further, the effect contour line may be determined based on the converted expansion contour points.

Alternatively, determining the effect contour line based on the expansion contour points comprises: determining the expansion contour points located in a target image area in the expanded image as effect contour points, and determining the effect contour line based on the effect contour points.

The target image area is an image area corresponding to the object mask image. It should be noted that the target image area may also be an image area corresponding to the target image, that is, an image area corresponding to the same coordinate system as the target image.

In practical applications, after the expansion contour points are determined, the expansion contour points may be processed based on the target image area to determine the expansion contour points located in the target image area in the expanded image as the effect contour points. Specifically, expansion coordinate values of the expansion contour points in the expanded image may be obtained, and a coordinate conversion is performed on the expansion coordinate values corresponding to the expansion contour points based on the target image area to obtain original coordinate values of the expansion contour points in the target image area. Further, the expansion contour points with the original coordinate values being a positive number may be screened out from the original coordinate values corresponding to the expansion contour points, and the expansion contour points obtained by the screening may be determined as expansion contour points located in the target image area in the expanded image and as the effect contour points. Therefore, the effect contour line may be determined based on the effect contour points. The advantage of this arrangement is that locations of the expansion contour points in the target image can be determined, and then an approximate contour of the effect contour line can be determined, and the effect that a certain distance exists between the effect contour line and the outer contour line of the target object can be displayed.

Generally, in a case where a plurality of points are determined, determining one line is based on the plurality of points may be directly connecting the plurality of points, and determining the connected line as a required line; or, to make the finally obtained line smoother, smoothing the plurality of points, and then the required line may be determined based on the smoothed points. Therefore, in the embodiments of the present disclosure, determining the effect contour line based on the effect contour points may comprise at least two manners, which are separately described below.

In a first manner, generating the effect contour line based on the effect contour points comprises: determining a line constructed by the effect contour points as the effect contour line.

In practical applications, after the effect contour points are obtained, respective effect contour points may be connected based on coordinate values corresponding to the respective effect contour points, and the line obtained through connection is determined as the effect contour line.

In a second manner, generating the effect contour line based on the effect contour points comprises: determining the effect contour points to be processed as contour points to be updated, obtaining a predetermined number of the effect contour points adjacent to locations of the contour points to be updated as reference contour points, updating the contour points to be updated based on the contour points to be updated and the reference contour points, and determining a line constructed based on the updated contour points to be updated as the effect contour line.

The contour points to be updated may be understood as effect contour points of a display location to be updated, and may be specifically effect contour points that need to be smoothed. The number of contour points to be updated may be at least some of the determined effect contour points. The display location of the contour points to be updated may be represented by location coordinates of the contour points to be updated in the target image area. The predetermined number may be any value, alternatively, 1, 2, or 3. The reference contour points may be understood as effect contour points adjacent to display locations of the contour points to be updated. The number of reference contour points may be any number, e.g., 4, 6, or the like.

Alternatively, performing mean smoothing on the contour points to be updated may be determining effect contour points in a predetermined area corresponding to the contour points to be updated as the reference contour points. Specifically, for each contour point to be updated, the contour point to be updated may be determined as a center point, and a predetermined distance is determined as a radius to construct the predetermined area corresponding to the contour points to be updated. Further, effect contour points other than the center point in the predetermined area may be obtained, and these effect contour points may be determined as reference contour points. The predetermined distance may be any value, alternatively, may be a distance corresponding to 3 effect contour points.

In practical applications, the line constructed by the effect contour points is directly determined as the effect contour line, which may cause the effect contour line to appear jagged or discontinuous. To avoid this situation, the effect contour points may be smoothed. Specifically, the effect contour points to be processed may be determined in all the determined effect contour points, and the effect contour points to be processed may be determined as the contour points to be updated. Further, the location coordinates of the contour points to be updated may be determined. Then, the predetermined number of effect contour points adjacent to the locations of the contour points to be updated may be determined based on the location coordinates, and the effect contour points are determined as the reference contour points corresponding to the contour points to be updated. Further, the contour points to be updated may be updated based on the locations of the contour points to be updated and the locations of the reference contour points. Further, after each of the determined contour points to be updated is updated, the contour points to be updated in the effect contour points may be replaced with the updated contour points to be updated to obtain the replaced effect contour points. Therefore, each of the replaced effect contour points may be connected based on its corresponding location coordinate to obtain the effect contour line.

It should be noted that updating the contour points to be updated based on the display locations of the reference contour points corresponding to the contour points to be updated may be understood as performing mean smoothing on the contour points to be updated. Alternatively, updating the contour points to be updated based on the contour points to be updated and the reference contour points comprises: determining an average value of original locations of the contour points to be updated and original locations of the reference contour points as a target location of the contour points to be updated, and updating the contour points to be updated based on the target location.

Specifically, locations of the contour points to be updated and the reference contour points corresponding to the contour points to be updated are obtained. Further, an average value of these locations may be determined, and the average value may be used to replace the locations of the contour points to be updated to update the contour points to be updated.

In the embodiments of the present disclosure, the contour points to be updated and the reference contour points are effect contour points. The original locations of the contour points to be updated and the original locations of the reference contour points may be understood as location coordinates of the effect contour points in the target image area without smoothing. The target location may be understood as a location coordinate of the effect contour points that have been smoothed.

In practical applications, for each of the contour points to be updated, reference contour points corresponding to the contour points to be updated may be determined. Further, location coordinates of the original locations of the contour points to be updated and location coordinates of the original locations of the reference contour points may be obtained. Further, the location coordinates of the contour points to be updated may be added to the location coordinates of the reference contour points, the ratio between the added coordinate values and the total number of the contour points to be updated and the reference contour points may be determined. The ratio may be determined as the target location of the contour points to be updated, and the original locations of the contour points to be updated may be replaced with the target location to update the contour points to be updated.

For example, for each of the contour points to be updated, a predetermined number (for example, 2, 3, 4, or the like) effect contour points located on two sides of the contour points to be updated may be respectively obtained along the arrangement direction of the plurality of effect contour points as the reference contour points corresponding to the contour point to be updated. Further, the target location of the contour points to be updated may be determined based on the location coordinates of the contour points to be updated and the location coordinates of the reference contour point.

Further, a line constructed by the updated contour points to be updated may be determined as the effect contour line.

In the embodiments of the present disclosure, after the effect contour line is obtained, the effect contour line may be rendered into the target image to obtain the effect image.

In practical applications, rendering the effect contour line into the target image may be understood as constructing a line virtual model corresponding to the effect contour line, and determining texture information corresponding to the line virtual model. Further, the line virtual model and the corresponding texture information may be rendered by a rendering engine to obtain the effect image, so that the effect contour line can be displayed in the effect image with corresponding texture information.

Alternatively, rendering the effect contour line into the target image to obtain the effect image comprises: constructing, for each of the points to be rendered on the effect contour line, a point-based three-dimensional model corresponding to the points to be rendered, and determining target texture information corresponding to the point-based three-dimensional model; and rendering the point-based three-dimensional model into the target image based on the target texture information to obtain the effect image.

The points to be rendered may be understood as pixels that need to be rendered on the effect contour line. The point-based three-dimensional model may be understood as a three-dimensional model constructed based on the points to be rendered. The point-based three-dimensional model may be composed of at least one facets, and each facet may be composed of at least three vertices. The facet may be determined as a network model, and the vertices may be determined as vertices of the model. Alternatively, the point-based three-dimensional model may be a cube model centered on the points to be rendered, or a sphere model centered on the points to be rendered. The target texture information may be understood as a sticker with a pattern, and in the rendering process, the sticker is applied on the model surface of the point-based three-dimensional model, so that each point of the effect contour line in the effect image displays an effect corresponding to the pattern of the sticker. It should be noted that the target texture information may be a sticker from a material library in application software that is pre-generated and stored; or may be a sticker stored in a local storage space (for example, an album) of the current terminal device; or may be a sticker uploaded in real time by an external device; or may a sticker generated in real time. For example, as shown in FIG. 6, it is a schematic diagram of target texture information.

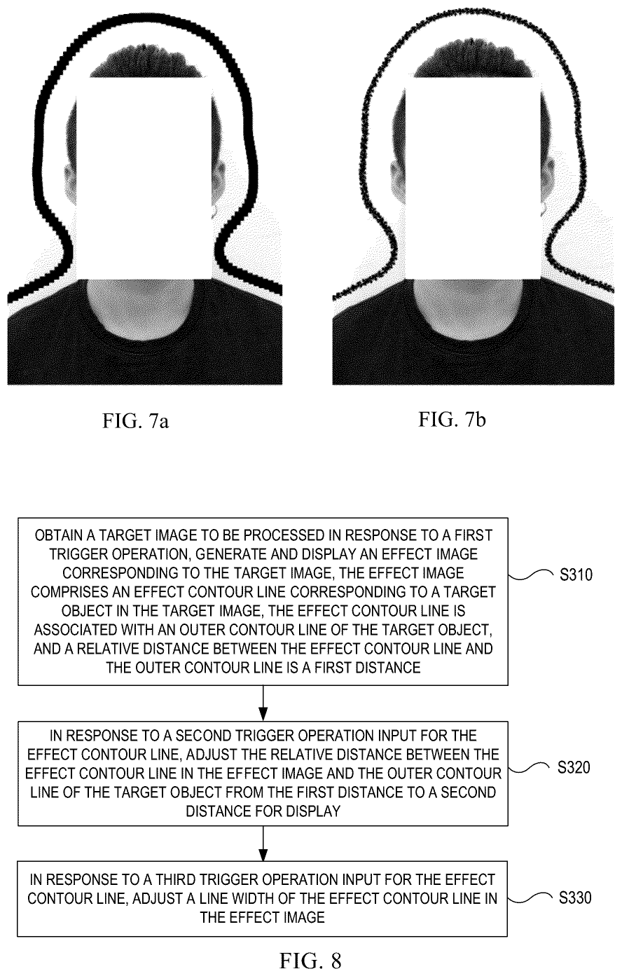

In practical applications, for each point to be rendered on the effect contour line, a point-based three-dimensional model centered on the point to be rendered may be constructed based on a predetermined model construction parameter, and target texture information corresponding to the point-based three-dimensional model may be determined. Further, pixel information corresponding to the target texture information may be filled in the point-based three-dimensional model, so that the point-based three-dimensional model may be rendered into the target image based on the target texture information, thereby obtaining the effect image. For example, FIG. 7a is a schematic diagram of an effect of rendering a point-based three-dimensional model without target texture information into a target image, and FIG. 7b is a schematic diagram of an effect of rendering a point-based three-dimensional model filled with target texture information into a target image. The filled target texture information may be the target texture information shown in FIG. 6.

It should be noted that the target texture information corresponding to the point-based three-dimensional model of each point to be rendered may be the same or different, which is not specifically limited in the embodiments of the present disclosure.

S240: in response to a second trigger operation input for the effect contour line, the predetermined expansion parameter is adjusted, the expanded image is updated based on the adjusted predetermined expansion parameter, and the effect image is updated based on the updated expanded image, such that the relative distance between the effect contour line in the effect image and the outer contour line of the target object is adjusted from the first distance to the second distance.

In practical applications, in a case where the second trigger operation input for the effect contour line is detected, an adjustment distance corresponding to the second trigger operation may be determined, and the predetermined expansion parameter is adjusted based on the adjustment distance. Further, the expanded image may be updated based on the adjusted predetermined expansion parameter, and the updated effect contour points may be determined based on the updated expanded image. Then, the effect contour line may be updated based on the updated effect contour points, and the updated effect contour line is rendered into the target image to update the effect image. Therefore, the relative distance between the effect contour line in the effect image and the outer contour line of the target object may be adjusted from the first distance to the second distance.

According to the technical solution of the embodiments of the present disclosure, a target image to be processed is obtained in response to a first trigger operation, an object mask image corresponding to the target object in the target image is determined, and image boundary expanding is performed on the object mask image to obtain a mask expanded image. Then, the mask expanded image is expanded based on a predetermined expansion parameter to obtain an expanded image, and outer contour points of the target object in the expanded image are obtained as expansion contour points. After that, an effect contour line is determined based on the expansion contour points, the effect contour line is rendered into the target image to obtain the effect image, and the effect image is displayed. The effect image comprises an effect contour line corresponding to a target object in the target image. The effect contour line is associated with the outer contour line of the target object. A relative distance between the effect contour line and the outer contour line is the first distance. Furthermore, in response to a second trigger operation input for the effect contour line, the predetermined expansion parameter is adjusted, the expanded image is updated based on the adjusted predetermined expansion parameter, and the effect image is updated based on the updated expanded image, such that the relative distance between the effect contour line in the effect image and the outer contour line of the target object is adjusted from the first distance to the second distance. The effect of ensuring a relative distance between the effect contour line and the outer contour line in the effect image has been achieved, which improves the effect display of the effect contour line in the effect image, and furthermore, improves the intelligence of effect props and enhances the user experience of using effect props.

FIG. 8 is a schematic flowchart of a further method of image processing according to the embodiments of the present disclosure. On the basis of the foregoing embodiments, after the effect image is obtained, a third trigger operation input for the effect contour line in the effect image may be performed. Then, a line width of the effect contour line in the effect image may be adjusted based on the third trigger operation. For a specific implementation, reference may be made to the description of the embodiments of the present disclosure. Technical features that are the same as or similar to the foregoing embodiments are not described here again.

As shown in FIG. 8, the method in the embodiments of the present disclosure may specifically comprises the following.

S310: a target image to be processed is obtained in response to a first trigger operation, an effect image corresponding to the target image is generated and displayed. The effect image comprises an effect contour line corresponding to a target object in the target image. The effect contour line is associated with an outer contour line of the target object, and a relative distance between the effect contour line and the outer contour line is a first distance.

S320: in response to a second trigger operation input for the effect contour line, the relative distance between the effect contour line in the effect image and the outer contour line of the target object is adjusted from the first distance to a second distance for display.

S330: in response to a third trigger operation input for the effect contour line, a line width of the effect contour line in the effect image is adjusted.

It should be noted that there is no fixed execution order between S320 and S330, and S320 may be performed first, or S330 may be performed first. The execution order of the two steps may be determined based on the adjustment needs for the effect contour line of users.

The third trigger operation may be understood as a trigger operation of width adjustment, that is, an operation for adjusting the display width of the effect contour line after being triggered. In the embodiments of the present disclosure, a width adjustment control may be preset on a display interface of the effect image, so that the user may adjust the display width of the effect contour line by triggering the control. The width adjustment control may be any form of control, alternatively, it may be a slider, edit box or other forms of control. The line width may be understood as a line display width of the effect contour line in the effect image, that is, a line thickness degree of the effect contour line in the effect image.

In practical applications, after the effect image is determined, and the effect image is displayed in the display interface, a preset width adjustment control may also be displayed in the display interface. In a case where a trigger operation for the width adjustment control is detected, it may be determined that the third trigger operation input for the effect contour line is detected. Further, the trigger operation may be responded to, and the line width of the effect contour line in the effect image may be adjusted.

It should be noted that the effect image is obtained by rendering the effect contour line into the target image, and in the rendering process, the point-based three-dimensional model of each point to be rendered on the effect contour line is rendered into the target image to implement the rendering process of the effect contour line. Therefore, the line width of the effect contour line in the effect image may be determined based on the model size of the point-based three-dimensional model corresponding to each effect contour point. Further, when the line width of the effect contour line in the effect image is adjusted, the model size of the point-based three-dimensional model of each point to be rendered on the effect contour line may be adjusted. Therefore, the effect contour line may be rendered into the effect image based on the adjusted point-based three-dimensional model.

Alternatively, adjusting the line width of the effect contour line in the effect image comprises: determining a line-based three-dimensional model corresponding to the effect contour line, the line-based three-dimensional model comprising a point-based three-dimensional model corresponding to each of the effect contour points on the effect contour line; and adjusting a model size of the point-based three-dimensional model, and rendering the effect contour line into the effect image based on the point-based three-dimensional model after size adjustment.

In the embodiments of the present disclosure, the line-based three-dimensional model may be a model constructed based on a point-based three-dimensional model corresponding to each effect contour point.

In practical applications, in a case where the third trigger operation input for the effect contour line is detected, the trigger operation may be responded to, and a line-based three-dimensional model corresponding to the effect contour line is determined. The line-based three-dimensional model includes a point-based three-dimensional model corresponding to each effect contour point. Further, the model size of each point-based three-dimensional model may be adjusted based on the detected third trigger operation. Further, the effect contour line may be updated based on the point-based three-dimensional model after the size adjustment, and the updated effect contour line is rendered into the effect image. Therefore, the line width of the effect contour line in the finally obtained effect image may be the adjusted line width.

According to the technical solution provided by the embodiments of the present disclosure, a target image to be processed is obtained in response to a first trigger operation, and an effect image corresponding to the target image is generated and displayed. The effect image comprises an effect contour line corresponding to a target object in the target image, the effect contour line is associated with an outer contour line of the target object, and a relative distance between the effect contour line and the outer contour line is a first distance. Further, in response to a second trigger operation input for the effect contour line, the relative distance between the effect contour line in the effect image and the outer contour line of the target object is adjusted from the first distance to a second distance for display. In response to a third trigger operation input for the effect contour line, a line width of the effect contour line in the effect image is adjusted. The effect of adjusting the display width of the effect contour line in the effect image has been achieved, which enhances the effect display of the effect contour line, enhances the richness and interest of the effect image content, while also strengthening the interaction effect with users.

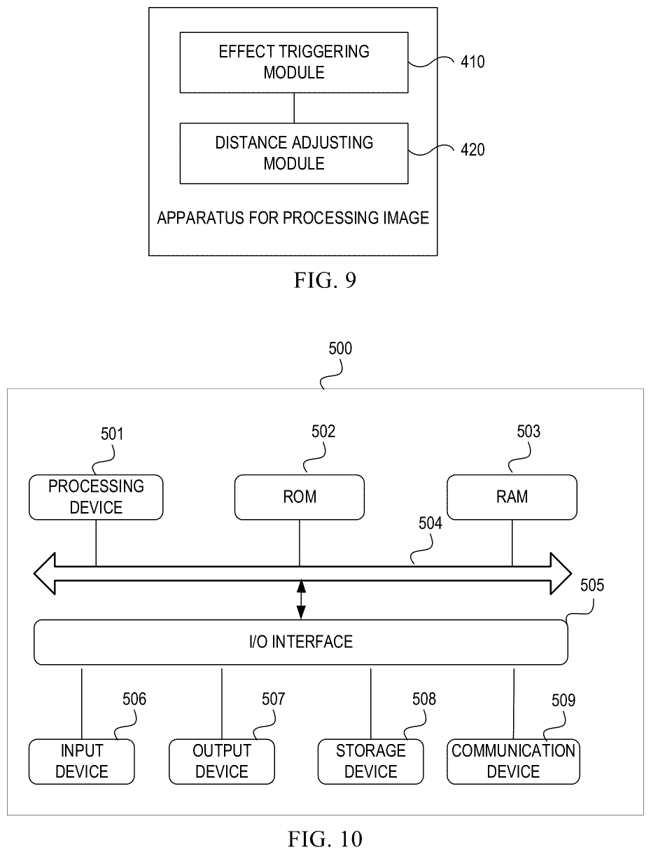

FIG. 9 is a schematic structural diagram of an apparatus for image processing according to the embodiments of the present disclosure. As shown in FIG. 9, the apparatus comprises an effect triggering module 410 and a distance adjusting module 420.

The effect triggering module 410 is configured to obtain a target image to be processed in response to a first trigger operation, generate an effect image corresponding to the target image, and display the effect image. The effect image comprises an effect contour line corresponding to a target object in the target image. The effect contour line is associated with an outer contour line of the target object, and a relative distance between the effect contour line and the outer contour line is a first distance. The distance adjusting module 420 is configured to, in response to a second trigger operation input for the effect contour line, adjust the relative distance between the effect contour line in the effect image and the outer contour line of the target object from the first distance to a second distance for display.

Based on the foregoing alternative technical solutions, alternatively, the effect triggering module 410 comprises a mask image determining submodule, an expanded image determining submodule, and an effect contour line determining submodule.

The mask image determining submodule is configured to determine an object mask image corresponding to the target object in the target image, and perform image boundary expanding on the object mask image to obtain a mask expanded image.

The expanded image determining submodule is configured to expand the mask expanded image based on a predetermined expansion parameter to obtain an expanded image, and obtain outer contour points of the target object in the expanded image as expansion contour points.

The effect contour line determining submodule is configured to determine an effect contour line based on the expansion contour points, render the effect contour line into the target image to obtain the effect image, and display the effect image.

On the basis of the foregoing alternative technical solutions, alternatively, the effect contour line determining submodule comprises a contour point determining unit.

The contour point determining unit is configured to determine the expansion contour points located in a target image area in the expanded image as effect contour points, and determine the effect contour line based on the effect contour points, where the target image area is an image area corresponding to the object mask image.

On the basis of the foregoing alternative technical solutions, alternatively, the contour point determining unit comprises a first contour line determining unit and/or a second contour line determining unit.

The first contour line determining unit is configured to determine a line constructed by the effect contour points as the effect contour line; and/or the second contour line determining unit is configured to determine the effect contour points to be processed as contour points to be updated, obtain a predetermined number of the effect contour points adjacent to locations of the contour points to be updated as reference contour points, update the contour points to be updated based on the contour points to be updated and the reference contour points, and determine a line constructed based on the updated contour points to be updated as the effect contour line.

On the basis of the foregoing alternative technical solutions, alternatively, the second contour line determining unit is specifically configured to determine an average value of original locations of the contour points to be updated and original locations of the reference contour points as a target location of the contour points to be updated, and update the contour points to be updated based on the target location.

On the basis of the foregoing alternative technical solutions, alternatively, the effect contour line determining submodule comprises a point-based three-dimensional model constructing unit and an effect image determining unit.

The point-based three-dimensional model constructing unit is configured to construct, for each of the points to be rendered on the effect contour line, a point-based three-dimensional model corresponding to the points to be rendered, and determine target texture information corresponding to the point-based three-dimensional model.

The effect image determining unit is configured to render the point-based three-dimensional model into the target image based on the target texture information to obtain the effect image.

On the basis of the foregoing alternative technical solutions, alternatively, the distance adjusting module 420 comprises an expanded image updating unit.

The expanded image updating unit is configured to adjust the predetermined expansion parameter, update the expanded image based on the adjusted predetermined expansion parameter, and update the effect image based on the updated expanded image, such that the relative distance between the effect contour line in the effect image and the outer contour line of the target object is adjusted from the first distance to the second distance.

On the basis of the foregoing alternative technical solutions, alternatively, the apparatus further comprises a line width adjusting module.

The line width adjusting module is configured to, after the generating and displaying an effect image corresponding to the target image, in response to a third trigger operation input for the effect contour line, adjust a line width of the effect contour line in the effect image.

On basis of the foregoing alternative technical solutions, alternatively, the line width adjusting module comprises a line-based three-dimensional model determining unit and a model size adjusting unit.

The line-based three-dimensional model determining unit is configured to determine a line-based three-dimensional model corresponding to the effect contour line. The line-based three-dimensional model comprises a point-based three-dimensional model corresponding to each of the effect contour points on the effect contour line.

The model size adjusting unit is configured to adjust a model size of the point-based three-dimensional model, and render the effect contour line into the effect image based on the point-based three-dimensional model after size adjustment.

According to the technical solution provided by the embodiments of the present disclosure, a target image to be processed is obtained by the effect triggering module in response to a first trigger operation, and an effect image corresponding to the target image is generated and displayed. The effect image comprises an effect contour line corresponding to a target object in the target image, the effect contour line is associated with an outer contour line of the target object, and a relative distance between the effect contour line and the outer contour line is a first distance. Therefore, an effect associated with the outer contour line of the target object is provided. Further, in response to a second trigger operation input for the effect contour line, the relative distance between the effect contour line in the effect image and the outer contour line of the target object is adjusted by the distance adjusting module from the first distance to a second distance for display. In this way, an interaction entrance for adjusting the effect is provided for users, and the problem in the related art is solved, which is that the effect in the effect image or the effect video cannot be adjusted, resulting in a relatively monotonous visual effect of the effect image or the effect video created based on the effect prop, and the inability to meet the diverse editing needs of users for the effects of the effect prop. It realizes the effect of allowing users to customize the relative distance between the effect contour line and the target object in the effect image, enhancing the richness and interest of the effect image content, while also strengthening the interactive effect with users and improving their user experience with the effect prop.

The apparatus for image processing provided by the embodiments of the present disclosure may perform the method of image processing provided by any embodiment of the present disclosure, and has functional modules and beneficial effects corresponding to the implementation method.

It should be noted that the units and modules included in the foregoing apparatus are only divided based on the function logic, but are not limited to the foregoing division, as long as the corresponding functions can be implemented; in addition, the specific names of the functional units are merely for ease of distinguishing, and are not intended to limit the protection scope of the embodiments of the present disclosure.

FIG. 10 is a schematic structural diagram of an electronic device according to the embodiments of the present disclosure. FIG. 10 is a schematic structural diagram of an electronic device (such as the terminal device or server in FIG. 10) suitable for implementing the embodiments of the present disclosure. The terminal device in the embodiments of the present disclosure may include but is not limited to, a mobile terminal such as a mobile phone, a notebook computer, a digital broadcast receiver, a personal digital assistant (PDA), a tablet computer (PAD), a portable multimedia player (PMP), an in-vehicle terminal (for example, an in-vehicle navigation terminal), and a fixed terminal such as a digital TV, a desktop computer, or the like. The electronic device shown in FIG. 10 is merely an example, and should not impose any limitation on the functions and scope of use of the embodiments of the present disclosure.

As shown in FIG. 10, the electronic device 500 may include a processing device (for example, a central processing unit, a graphics processor, and so on) 501, which may perform various appropriate actions and processing according to a program stored in a read-only memory (ROM) 502 or a program loaded into a random access memory (RAM) 503 from a storage device 508. In the RAM 503, various programs and data required by the operation of the electronic device 500 are also stored. The processing device 501, the ROM 502, and the RAM 503 are connected to each other through a bus 504. An edit/output (I/O) interface 505 is also connected to the bus 504.

Generally, the following devices may be connected to the I/O interface 505: an input device 506 including, for example, a touch screen, a touchpad, a keyboard, a mouse, a camera, a microphone, an accelerometer, a gyroscope, or the like; an output device 507 including, for example, a liquid crystal display (LCD), a speaker, a vibrator, or the like; a storage device 508 including, for example, a magnetic tape, a hard disk, or the like; and a communication device 509. The communication device 509 may allow the electronic device 500 to communicate wirelessly or wired with other devices to exchange data. While FIG. 10 shows an electronic device 500 having various devices, it should be understood that it is not required to implement or have all illustrated devices. More or fewer devices may alternatively be implemented or provided.

In particular, according to the embodiments of the present disclosure, the process described above with reference to the flowchart may be implemented as a computer software program. For example, embodiments of the present disclosure include a computer program product comprising a computer program embodied on a non-transitory computer-readable medium, the computer program comprising program code for performing the method shown in the flowchart. In such embodiments, the computer program may be downloaded and installed from the network through the communication device 509, or installed from the storage device 508, or from the ROM 502. When the computer program is executed by the processing device 501, the foregoing functions defined in the method of the embodiments of the present disclosure are performed.

The names of messages or information interaction between multiple devices in embodiments of the present disclosure are for illustrative purposes only and are not intended to limit the scope of such messages or information.

The electronic device provided by the embodiments of the present disclosure and the method of image processing provided in the above embodiments belong to the same inventive concept, technical details not described in detail in this embodiment may refer to the foregoing embodiments, and the present embodiment has the same beneficial effects as the foregoing embodiments.

An embodiment of the present disclosure provides a computer storage medium having a computer program stored thereon, the program, when executed by a processor, implements the method of image processing provided in the foregoing embodiments.

It should be noted that the computer-readable medium described above may be a computer-readable signal medium, a computer-readable storage medium, or any combination of the foregoing two. The computer-readable storage medium may be, for example, but not limited to, an electrical, magnetic, optical, electromagnetic, infrared, or semiconductor system, device, or device, or any combination thereof. More specific examples of computer-readable storage media may include but are not limited to, an electrical connection having one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing. In the present disclosure, a computer-readable storage medium may be any tangible medium containing or storing a program that may be used by or in connection with an instruction execution system, apparatus, or device. In the present disclosure, a computer-readable signal medium may include a data signal propagated in a baseband or as part of a carrier, where the computer-readable program code is carried. Such propagated data signals may take a variety of forms including, but not limited to, electromagnetic signals, optical signals, or any suitable combination of the foregoing. The computer-readable signal medium may also be any computer-readable medium other than a computer-readable storage medium that may send, propagate, or transmit a program for use by or in connection with an instruction execution system, apparatus, or device. The program code embodied on the computer-readable medium may be transmitted with any suitable medium, including, but not limited to: wires, optical cables, radio frequency (RF), and the like, or any suitable combination of the foregoing.

In some implementations, the client, server may communicate using any currently known or future-developed network protocol, such as HyperText Transfer Protocol (HTTP), and may be interconnected with any form or medium of digital data communication (for example, a communication network). Examples of communication networks include local area networks (“LANs”), wide area networks (“WANs”), Internet (e.g., the Internet), and peer-to-peer networks (e.g., ad hoc peer-to-peer networks), as well as any currently known or future developed networks.

The computer-readable medium described above may be included in the electronic device; or may be separately present without being assembled into the electronic device.

The computer-readable medium carries one or more programs, and when the one or more programs are executed by the electronic device, the electronic device is caused to: obtain a target image to be processed in response to a first trigger operation, generate an effect image corresponding to the target image, and display the effect image, the effect image comprising an effect contour line corresponding to a target object in the target image, the effect contour line being associated with an outer contour line of the target object, and a relative distance between the effect contour line and the outer contour line being a first distance; and in response to a second trigger operation input for the effect contour line, adjust the relative distance between the effect contour line in the effect image and the outer contour line of the target object from the first distance to a second distance for display.

Computer program code for performing the operations of the present disclosure may be written in one or more programming languages, including, but not limited to, object-oriented programming languages such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected through the Internet using an Internet service provider).

The flowcharts and block diagrams in the figures illustrate the architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than those illustrated in the figures. For example, two consecutively represented blocks may be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations or may be implemented in a combination of dedicated hardware and computer instructions.

The units involved in the embodiments of the present disclosure may be implemented in software or may be implemented in hardware. For example, the first obtaining unit may be further described as “obtaining at least two units of Internet Protocol addresses”.

The functions described above may be performed, at least in part, by one or more hardware logic components. For example, without limitation, exemplary types of hardware logic components that may be used include field programmable gate arrays (FPGAs), application-specific integrated circuits (ASICs), application-specific standard products (ASSPs), system-on-a-chip (SOCs), complex programmable logic devices (CPLDs), and the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or flash memory), optical fibers, portable compact disc read-only memory (CD-ROM), optical storage devices, magnetic storage devices, or any suitable combination of the foregoing.

According to one or more embodiments of the present disclosure, [Example 1] there is provided the method of image processing, which comprises:
obtaining a target image to be processed in response to a first trigger operation, generating and displaying an effect image corresponding to the target image, the effect image comprising an effect contour line corresponding to a target object in the target image, the effect contour line being associated with an outer contour line of the target object, and a relative distance between the effect contour line and the outer contour line being a first distance; and in response to a second trigger operation input for the effect contour line, adjusting the relative distance between the effect contour line in the effect image and the outer contour line of the target object from the first distance to a second distance for display.

According to one or more embodiments of the present disclosure, [Example 2] there is provided a method of Example 1, which comprises:
alternatively, the generating and displaying an effect image corresponding to the target image comprises: determining an object mask image corresponding to the target object in the target image, and performing image boundary expanding on the object mask image to obtain a mask expanded image; expanding the mask expanded image based on a predetermined expansion parameter to obtain an expanded image, and obtaining outer contour points of the target object in the expanded image as expansion contour points; and determining an effect contour line based on the expansion contour points, rendering the effect contour line into the target image to obtain the effect image, and displaying the effect image.

According to one or more embodiments of the present disclosure, [Example 3] there is provided a method of Example 2, which comprises:
alternatively, determining an effect contour line based on the expansion contour points comprises: determining the expansion contour points located in a target image area in the expanded image as effect contour points, and determining the effect contour line based on the effect contour points, where the target image area is an image area corresponding to the object mask image.

According to one or more embodiments of the present disclosure, [Example 4] there is provided a method of Example 3, which comprises:
alternatively, the generating the effect contour line based on the effect contour points comprises: determining a line constructed by the effect contour points as the effect contour line; and/or determining the effect contour points to be processed as contour points to be updated, obtaining a predetermined number of the effect contour points adjacent to locations of the contour points to be updated as reference contour points, updating the contour points to be updated based on the contour points to be updated and the reference contour points, and determining a line constructed based on the updated contour points to be updated as the effect contour line.

According to one or more embodiments of the present disclosure, [Example 5] there is provided a method of Example 4, which further comprises:
alternatively, the updating the contour points to be updated based on the contour points to be updated and the reference contour points comprises: determining an average value of original locations of the contour points to be updated and original locations of the reference contour points as a target location of the contour points to be updated, and updating the contour points to be updated based on the target location.

According to one or more embodiments of the present disclosure, [Example 6] there is provided a method of Example 2, which further comprises:
alternatively, the rendering the effect contour line into the target image to obtain the effect image comprises: constructing, for each of the points to be rendered on the effect contour line, a point-based three-dimensional model corresponding to the points to be rendered, and determining target texture information corresponding to the point-based three-dimensional model; and rendering the point-based three-dimensional model into the target image based on the target texture information to obtain the effect image

According to one or more embodiments of the present disclosure, [Example 7] there is a method of Example 2 is provided, which further comprises:
alternatively, the adjusting the relative distance between the effect contour line in the effect image and the outer contour line of the target object from the first distance to a second distance for display comprises: adjusting the predetermined expansion parameter, updating the expanded image based on the adjusted predetermined expansion parameter, and updating the effect image based on the updated expanded image, such that the relative distance between the effect contour line in the effect image and the outer contour line of the target object is adjusted from the first distance to the second distance.

According to one or more embodiments of the present disclosure, [Example 8] there is provided a method of example 8, which further comprises:
alternatively, after the generating and displaying an effect image corresponding to the target image, in response to a third trigger operation input for the effect contour line, adjusting a line width of the effect contour line in the effect image.

According to one or more embodiments of the present disclosure, [Example 9] there is provided a method of Example 8, which further comprises:
alternatively, the adjusting a line width of the effect contour line in the effect image comprises: determining a line-based three-dimensional model corresponding to the effect contour line, the line-based three-dimensional model comprising a point-based three-dimensional model corresponding to each of the effect contour points on the effect contour line; and adjusting a model size of the point-based three-dimensional model, and rendering the effect contour line into the effect image based on the point-based three-dimensional model after size adjustment.

According to one or more embodiments of the present disclosure, [Example 10] there is provided an apparatus for image processing, which comprises:
an effect triggering module configured to obtain a target image to be processed in response to a first trigger operation, generate an effect image corresponding to the target image, and display the effect image, the effect image comprising an effect contour line corresponding to a target object in the target image, the effect contour line being associated with an outer contour line of the target object, and a relative distance between the effect contour line and the outer contour line being a first distance; and
a distance adjusting module configured to, in response to a second trigger operation input for the effect contour line, adjust the relative distance between the effect contour line in the effect image and the outer contour line of the target object from the first distance to a second distance for display.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

I/We claim:

1. A method of image processing, comprising:
obtaining a target image to be processed in response to a first trigger operation, generating and displaying an effect image corresponding to the target image, the effect image comprising an effect contour line corresponding to a target object in the target image, the effect contour line being associated with an outer contour line of the target object, and a relative distance between the effect contour line and the outer contour line being a first distance; and
in response to a second trigger operation input for the effect contour line, adjusting the relative distance between the effect contour line in the effect image and the outer contour line of the target object from the first distance to a second distance for display.

2. The method of image processing of claim 1, wherein the generating and displaying an effect image corresponding to the target image comprises:
determining an object mask image corresponding to the target object in the target image, and performing image boundary expanding on the object mask image to obtain a mask expanded image;
expanding the mask expanded image based on a predetermined expansion parameter to obtain an expanded image, and obtaining outer contour points of the target object in the expanded image as expansion contour points; and
determining an effect contour line based on the expansion contour points, rendering the effect contour line into the target image to obtain the effect image, and displaying the effect image.

3. The method of image processing of claim 2, wherein the determining an effect contour line based on the expansion contour points comprises:
determining the expansion contour points located in a target image area in the expanded image as effect contour points, and determining the effect contour line based on the effect contour points, wherein the target image area is an image area corresponding to the object mask image.

4. The method of image processing of claim 3, wherein the generating the effect contour line based on the effect contour points comprises:
determining a line constructed by the effect contour points as the effect contour line; and/or
determining the effect contour points to be processed as contour points to be updated, obtaining a predetermined number of the effect contour points adjacent to locations of the contour points to be updated as reference contour points, updating the contour points to be updated based on the contour points to be updated and the reference contour points, and determining a line constructed based on the updated contour points to be updated as the effect contour line.

5. The method of image processing of claim 4, wherein the updating the contour points to be updated based on the contour points to be updated and the reference contour points comprises:
determining an average value of original locations of the contour points to be updated and original locations of the reference contour points as a target location of the contour points to be updated, and updating the contour points to be updated based on the target location.

6. The method of image processing of claim 2, wherein the rendering the effect contour line into the target image to obtain the effect image comprises:
constructing, for each of the points to be rendered on the effect contour line, a point-based three-dimensional model corresponding to the points to be rendered, and determining target texture information corresponding to the point-based three-dimensional model; and
rendering the point-based three-dimensional model into the target image based on the target texture information to obtain the effect image.

7. The method of image processing of claim 2, wherein the adjusting the relative distance between the effect contour line in the effect image and the outer contour line of the target object from the first distance to a second distance for display comprises:
adjusting the predetermined expansion parameter, updating the expanded image based on the adjusted predetermined expansion parameter, and updating the effect image based on the updated expanded image, such that the relative distance between the effect contour line in the effect image and the outer contour line of the target object is adjusted from the first distance to the second distance.

8. The method of image processing of claim 1, wherein the method further comprises: after the generating and displaying an effect image corresponding to the target image,
in response to a third trigger operation input for the effect contour line, adjusting a line width of the effect contour line in the effect image.

9. The method of image processing of claim 8, wherein the adjusting a line width of the effect contour line in the effect image comprises:
determining a line-based three-dimensional model corresponding to the effect contour line, the line-based three-dimensional model comprising a point-based three-dimensional model corresponding to each of the effect contour points on the effect contour line; and
adjusting a model size of the point-based three-dimensional model, and rendering the effect contour line into the effect image based on the point-based three-dimensional model after size adjustment.

10. An electronic device, comprising:
one or more processors;
a storage device storing one or more programs which, when executed by the one or more processors, cause the one or more processors to implement operations comprising:
obtaining a target image to be processed in response to a first trigger operation, generating and displaying an effect image corresponding to the target image, the effect image comprising an effect contour line corresponding to a target object in the target image, the effect contour line being associated with an outer contour line of the target object, and a relative distance between the effect contour line and the outer contour line being a first distance; and
in response to a second trigger operation input for the effect contour line, adjusting the relative distance between the effect contour line in the effect image and the outer contour line of the target object from the first distance to a second distance for display.

11. The electronic device of claim 10, wherein the generating and displaying an effect image corresponding to the target image comprises:
determining an object mask image corresponding to the target object in the target image, and performing image boundary expanding on the object mask image to obtain a mask expanded image;
expanding the mask expanded image based on a predetermined expansion parameter to obtain an expanded image, and obtaining outer contour points of the target object in the expanded image as expansion contour points; and
determining an effect contour line based on the expansion contour points, rendering the effect contour line into the target image to obtain the effect image, and displaying the effect image.

12. The electronic device of claim 11, wherein the determining an effect contour line based on the expansion contour points comprises:
determining the expansion contour points located in a target image area in the expanded image as effect contour points, and determining the effect contour line based on the effect contour points, wherein the target image area is an image area corresponding to the object mask image.

13. The electronic device of claim 12, wherein the generating the effect contour line based on the effect contour points comprises:
determining a line constructed by the effect contour points as the effect contour line; and/or
determining the effect contour points to be processed as contour points to be updated, obtaining a predetermined number of the effect contour points adjacent to locations of the contour points to be updated as reference contour points, updating the contour points to be updated based on the contour points to be updated and the reference contour points, and determining a line constructed based on the updated contour points to be updated as the effect contour line.

14. The electronic device of claim 13, wherein the updating the contour points to be updated based on the contour points to be updated and the reference contour points comprises:
determining an average value of original locations of the contour points to be updated and original locations of the reference contour points as a target location of the contour points to be updated, and updating the contour points to be updated based on the target location.

15. The electronic device of claim 11, wherein the rendering the effect contour line into the target image to obtain the effect image comprises:
constructing, for each of the points to be rendered on the effect contour line, a point-based three-dimensional model corresponding to the points to be rendered, and determining target texture information corresponding to the point-based three-dimensional model; and
rendering the point-based three-dimensional model into the target image based on the target texture information to obtain the effect image.

16. The electronic device of claim 11, wherein the adjusting the relative distance between the effect contour line in the effect image and the outer contour line of the target object from the first distance to a second distance for display comprises:
adjusting the predetermined expansion parameter, updating the expanded image based on the adjusted predetermined expansion parameter, and updating the effect image based on the updated expanded image, such that the relative distance between the effect contour line in the effect image and the outer contour line of the target object is adjusted from the first distance to the second distance.

17. The electronic device of claim 10, wherein the operations further comprise: after the generating and displaying an effect image corresponding to the target image,
in response to a third trigger operation input for the effect contour line, adjusting a line width of the effect contour line in the effect image.

18. The electronic device of claim 17, wherein the adjusting a line width of the effect contour line in the effect image comprises:
determining a line-based three-dimensional model corresponding to the effect contour line, the line-based three-dimensional model comprising a point-based three-dimensional model corresponding to each of the effect contour points on the effect contour line; and
adjusting a model size of the point-based three-dimensional model, and rendering the effect contour line into the effect image based on the point-based three-dimensional model after size adjustment.

19. A non-transitory storage medium comprising computer-executable instructions, wherein the computer-executable instructions, when executed by a computer processor, implement operations comprising:
obtaining a target image to be processed in response to a first trigger operation, generating and displaying an effect image corresponding to the target image, the effect image comprising an effect contour line corresponding to a target object in the target image, the effect contour line being associated with an outer contour line of the target object, and a relative distance between the effect contour line and the outer contour line being a first distance; and
in response to a second trigger operation input for the effect contour line, adjusting the relative distance between the effect contour line in the effect image and the outer contour line of the target object from the first distance to a second distance for display.

20. The non-transitory storage medium of claim 19, wherein the generating and displaying an effect image corresponding to the target image comprises:
determining an object mask image corresponding to the target object in the target image, and performing image boundary expanding on the object mask image to obtain a mask expanded image;
expanding the mask expanded image based on a predetermined expansion parameter to obtain an expanded image, and obtaining outer contour points of the target object in the expanded image as expansion contour points; and
determining an effect contour line based on the expansion contour points, rendering the effect contour line into the target image to obtain the effect image, and displaying the effect image.
